(19) United States
(12) Patent Application Publication
(10) Pub. No.: US 2016/0021305 A1
(43) Pub. Date: Jan. 21, 2016

(54) METHOD AND APPARATUS FOR MEASURING OPTICAL SYSTEMS AND SURFACES WITH OPTICAL RAY METROLOGY

(71) Applicant: Arizona Optical Systems, LLC, Tucson, AZ (US)

(72) Inventors: Benjamin J. Lewis, Tucson, AZ (US); Martin J. Valente, Tucson, AZ (US)

(21) Appl. No.: 14/742,529

(22) Filed: Jun. 17, 2015

Related U.S. Application Data
(60) Provisional application No. 62/026,482, filed on Jul. 18, 2014.

(51) Int. Cl. H04N 5/232; H04N 5/247; H04N 5/225

(52) U.S. Cl. CPC H04N 5/23229; H04N 5/2256; H04N 5/247

(57) ABSTRACT

Systems and methods for measuring an optical system are provided. A method of measuring an optical system includes the steps of: illuminating the optical system using a modulated diffuse optical source; simultaneously imaging light that has been altered by the optical system using a plurality of sensors positioned at different vantage points; determining, based on images from each of the sensors, the mapping relations between points on the optical system and corresponding geometric locations of points in the diffuse optical source; and determining, based on the mapping relations for each of the sensors, properties of the optical system.

### CROSS REFERENCE TO RELATED APPLICATION

This application claims priority from U.S. Provisional Application Ser. No. 62/026,482, filed Jul. 18, 2014, the contents of which are incorporated hereby reference.

### FIELD OF THE DISCLOSURE

The present disclosure is generally related to optical system measurement, and more particularly is related to systems and methods for measuring multiple surfaces of an optical system or lens.

### BACKGROUND OF THE DISCLOSURE

Deflectometry is the process of measuring the angular change of rays of light, and using this information to determine properties of the surface or system that created the deflection. Two classes of systems are known: scanning systems that provide well-controlled incident beams of light, and imaging systems that use diffuse light as the source and use imaging optics to define the rays of light.

One specific implementation of the latter type, with a diffuse source, is known as Phase Measuring Deflectometry. Phase is determined at the light source, e.g., a display such as an LCD screen, using sinusoidal or other patterns displayed on the screen. FIG. 1 illustrates such a conventional system. A significant limitation of the conventional Phase Measuring Deflectometry systems is that such systems can only measure a single surface, or the overall transmitted wavefront.

Thus, a heretofore unaddressed need exists in the industry to address the aforementioned deficiencies and inadequacies.

### SUMMARY OF THE DISCLOSURE

Embodiments of the present disclosure provide systems and methods for measuring an optical system. Briefly described, in architecture, one embodiment of such a method, among others, can be implemented as follows. A method of measuring an optical system includes the steps of: illuminating the optical system using a modulated diffuse optical source; simultaneously imaging light that has been altered by the optical system using a plurality of sensors positioned at different vantage points; determining, based on images from each of the sensors, the mapping relations between points on the optical system and corresponding geometric locations of points in the diffuse optical source; and determining, based on the mapping relations for each of the sensors, properties of the optical system.

In such embodiment, the method may be characterized by one or more of the following features:

(a) wherein the optical source comprises patterns displayed on a digital display, and optionally varying the position of the digital display;

(b) wherein the optical source comprises patterns displayed on two digital displays, said displays having different positions and being coupled through a beamsplitter;

(c) wherein the optical source comprises an array of small sources that are modulated in position within a plane;

(d) wherein the optical source comprises an array of small sources that are modulated in position in three dimensions;

(e) wherein the optical source comprises a linear source that is modulated in position within a plane;

(f) wherein the optical source comprises a linear source that is modulated in position in three dimensions;

(g) wherein the optical source comprises an array of point sources that remain fixed, but have their image modulated with a moving mirror; and

(h) wherein the optical source comprises an array of point sources that remain fixed, but have their image modulated with a moving lens or optical element.

In such embodiment, the method may further comprise:

positioning an occluding mask between the optical source and the optical system, and optionally, further comprising:

modulating the position of the occluding mask.

In such embodiment the occluding mask may be a grating, and optionally, a grating which is phase shifted.

In such embodiment, the method may also be characterized by one or more of the following features:

(a) wherein the determined properties comprise prescription parameters for the optical system;

(b) wherein the determined properties comprise coefficients that describe modes for shape irregularity for one of more surfaces in the optical system;

(c) wherein the determined properties comprise the shape of a reflective surface of the optical system;

(d) wherein the determined properties comprise the phase of the transmitted wavefront of the optical system;

(e) further comprising:

determining, based on the mapping relations for each of the sensors, a calibration of errors in one or more of the sensors;

(f) further comprising:

determining, based on the mapping relations for each of the sensors, a calibration of errors in the optical source;

(g) wherein the determined properties comprise both surface shapes for a refractive optic, and wherein the optical system comprises a specular surface, and/or the position of the optical system is rotated, thereby enabling measurement of optical systems having an angular acceptance too large for measuring in a single measurement

(h) wherein the determined properties comprise the shape of a plurality of reflective and/or refractive surfaces of an optical system;

(i) wherein the determined properties comprise the diffractive behavior of the optical system;

(j) further comprising:

varying the position of the optical system, and optionally further comprising:

measuring a first portion of the optical system while the optical system is in a first position;

measuring a second portion of the optical system while the optical system is in a second position; and

generating a measurement of the full optical system by combining the measurements of the first and second portions.

in another embodiment, the present disclosure provides a method of measuring a specular optical surface that includes the steps of: illuminating the surface using a modulated diffuse optical source; simultaneously imaging light that has been reflected by the surface using a plurality of sensors, each of said sensors having a pupil with a different size or shape; and determining, based on images from each of the sensors, discontinuities of slope and height and variations in reflectivity or transmission of the optical surface.

In such embodiment, the method may be characterized by one or more of the following features:

(a) wherein the plurality of sensors provide different measurements of the properties of the optical surface on the basis of their respective pupils, wherein the different properties preferably include the shape of one or more reflective or refractive surfaces at different length- or spatial-scales;

(b) wherein one or more different optical element(s) are positioned in the pupil of each of the plurality of sensors, wherein the one or more optical element(s) preferably comprise at least one of: a waveplate, a polarizer, a depolarizer, a filter, an attenuator, a lens, a diffractive element, a hologram and any other element which changes the properties of the light incident on the detector;

(c) further comprising:

varying the position of the optical surface, and optionally further comprising:

measuring a first portion of the optical surface while the optical surface is in a first position;

measuring a second portion of the optical surface while the optical surface is in a second position; and

generating a measurement of the full optical surface by combining the measurements of the first and second portions; and

(d) further comprising:

determining, based on the mapping relations for each of the sensors, a calibration of errors in at least one of the sensors and the optical source.

In another embodiment, the present disclosure provides an apparatus for measuring an optical system. The apparatus includes a modulated diffuse optical source for illuminating the optical system during measurement and a plurality of imagers, each having a pupil. The imagers are positioned to image light that has been altered by the optical system during measurement. An electronic computer is configured to: coordinate the modulation of the optical source and the image acquisition by the plurality of imagers, and determine the ray mapping between first and second optical spaces of the optical system, wherein the first optical space includes an optical space between the optical source and the optical system, and the second optical space includes an optical space between the plurality of imagers and the optical system.

In such embodiment, the apparatus may be characterized by one or more of the following features:

(a) wherein the electronic computer is further configured to determine properties of the optical system;

(b) wherein the optical source comprises a digital display;

(c) further comprising a mechanism for varying the position of the digital display;

(d) wherein the optical source comprises two digital displays, said displays having different positions and being coupled through a beamsplitter;

(e) wherein the optical source comprises an array of small sources that are modulated in position within a plane;

(f) wherein the optical source comprises an array of small sources that are modulated in position in three dimensions;

(g) wherein the optical source comprises a linear source that is modulated in position within a plane;

(h) wherein the optical source comprises a linear source that is modulated in position in three dimensions;

(i) wherein the optical source comprises an array of point sources that remain fixed, and the apparatus further includes a movable mirror for modulating the image of the array of point sources; and

(j) wherein the optical source comprises an array of point sources that remain fixed, and the apparatus further includes a movable lens or optical element to modulate the image of the array of point sources.

In another embodiment, the present disclosure provides an apparatus for measuring an optical surface that includes a modulated diffuse optical source for illuminating the optical surface during measurement and a plurality of imagers, each having a pupil. The imagers are positioned to image light that has been reflected by the optical surface during measurement. An electronic computer is configured to: coordinate the modulation of the optical source and the image acquisition by the plurality of imagers, and determine, based on images acquired by the imagers, the optical surface shape, discontinuities of slope and height and variations in reflectivity or transmission of the optical surface.

In such embodiment, the apparatus may be characterized by one or more of the following features:

(a) wherein the optical source comprises a digital display, and optionally further comprising a mechanism for varying the position of the digital display.

(b) wherein the optical source comprises two digital displays, said displays having different positions and being coupled through a beamsplitter;

(c) further comprising a mechanism for varying the position of the optical surface; and

(d) wherein the electronic computer is further configured to:

determine the complete optical surface shape, including discontinuities

In yet another embodiment, the present disclosure provides an apparatus for measuring an optical surface that includes a modulated diffuse optical source for illuminating the optical surface during measurement, a modulated mask positioned between the optical source and the optical surface during measurement, and an imager having a pupil. The imager is positioned to image light that has been reflected by the optical surface during measurement. An electronic computer is included and is configured to: coordinate the modulation of the optical source and the mask, and the image acquisition by the imager, and determine, based on images acquired by the imagers, the optical surface shape including discontinuities of slope and height and variations in reflectivity of the optical surface.

In such embodiment, the apparatus may be characterized by one or more of the following features:

(a) wherein the optical source comprises a digital display, and optionally further comprising a mechanism for varying the position of the digital display;

(b) farther comprising a mechanism for varying the position of the mask;

(c) wherein the optical source comprises two digital displays, said displays having different positions and being coupled through a beamsplitter;

(d) wherein the mask includes one or more gratings;

(e) wherein the modulation of the mask comprises phase-shifting;

(f) wherein the optical source and mask form a moiré pattern, and optionally wherein the electronic computer is further configured to analyze the moiré pattern;

(g) further comprising a mechanism for varying the position of the optical surface;

(h) wherein the electronic computer is configured to determine the complete surface shape, including discontinuities; and

(i) comprising a plurality of imagers, and wherein at least one of the plurality of imagers preferably has a pupil of a different size or shape from at least another one of the plurality of imagers.

In another embodiment, the present disclosure provides an apparatus for measuring an optical system that includes a modulated diffuse optical source for illuminating the optical surface during measurement, and a plurality of imagers, each having a pupil. The imagers are positioned to image light that has been altered by the optical system during measurement, and the pupils are arrayed to increase capture range or measurement area. An electronic computer is included and is configured to: coordinate the modulation of the optical source and the image acquisition by the plurality of imagers, and determine the ray mapping between first and second optical spaces of the optical system, wherein the first optical space includes an optical space between the optical source and the optical system, and the second optical space includes an optical space between the plurality of imagers and the optical system.

In such embodiment, the apparatus may be characterized by one or more of the following:

(a) wherein the optical source comprises multiple sources arrayed to increase capture range or measurement area; and

(b) wherein the pupils are arrayed to further increase dynamic range, and wherein the multiple sources preferably are further arrayed to increase dynamic range.

The present invention significantly advances and modifies conventional measurement techniques, to allow the optical system under test to be measured more accurately and more completely than with conventional systems. Conventional Phase Measuring Deflectometry can only measure a single surface, or the overall transmitted wavefront. The optical system under test might be a lens, mirror, or window, or a system of optics, such as a zoom lens, or some phase or amplitude volume, such as a GRIN (GRadient INdex) lens, or hologram, or a grating, or a black-box with complex internal behavior. The system might be used in transmission or reflection, or some combination thereof. Both geometrical and wave-optics properties of the system under test may be determined. We call this system FORM, or Flexible Optical Ray Metrology.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram illustrating a conventional Phase Measuring Deflectometry system.

FIG. 2 is a schematic diagram illustrating additional features of the conventional Phase Measuring Deflectometry system of FIG. 1.

FIG. 3 is a schematic diagram illustrating a system for measuring an optical system, in accordance with an exemplary embodiment of the present disclosure.

FIG. 4 is a schematic diagram illustrating a system for measuring an optical system, in accordance with embodiments of the present disclosure.

FIG. 5 is a schematic diagram illustrating a system for measuring an optical system, in accordance with embodiments of the present disclosure.

FIG. 6 is a schematic diagram illustrating a system for measuring an optical system, in accordance with embodiments of the present disclosure.

FIG. 7 is a schematic diagram illustrating a system for measuring an optical system, in accordance with embodiments of the present disclosure.

FIG. 8 is a schematic diagram illustrating a system for measuring an optical system, in accordance with embodiments of the present disclosure.

FIG. 9 is a schematic diagram illustrating a system for measuring an optical system, in accordance with embodiments of the present disclosure.

FIG. 10 is a schematic diagram illustrating a system for measuring an optical system, in accordance with embodiments of the present disclosure.

FIG. 11 is a schematic diagram illustrating a system for measuring an optical system, in accordance with embodiments of the present disclosure.

FIG. 12 is a schematic diagram illustrating a system for measuring an optical system, in accordance with embodiments of the present disclosure.

FIG. 13 is a schematic diagram illustrating a system for measuring an optical system, in accordance with embodiments of the present disclosure.

FIG. 14 is an illustration of various pupil types and characteristics which may be utilized in embodiments provided by the present disclosure.

### DETAILED DESCRIPTION

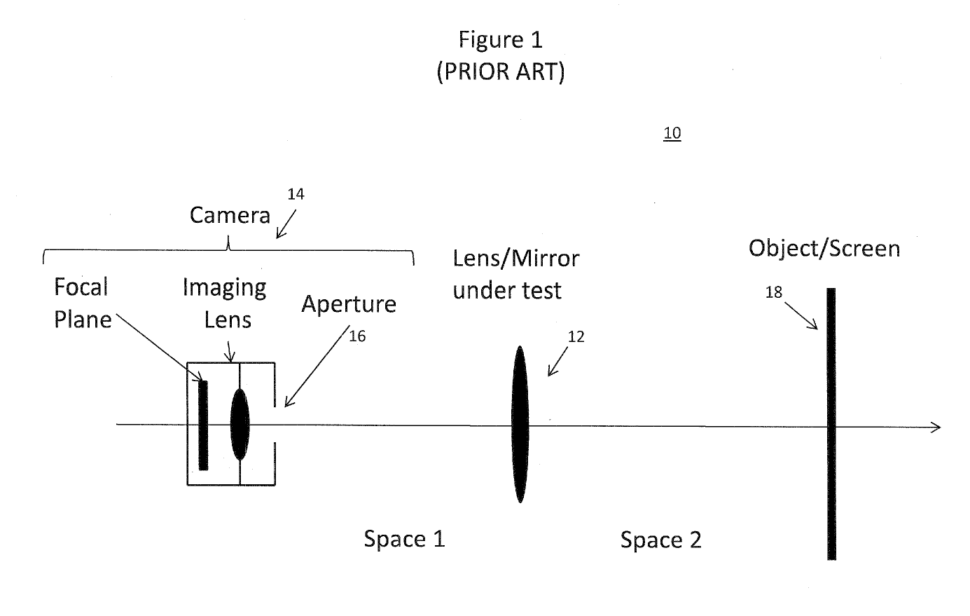

In the conventional Phase Measuring Deflectometry system 10, shown in FIG. 1, the measurement is performed by mapping the rays from a space on one side of the optical system under test (e.g., lens/mirror 12), to the conjugate space on the other side of the optical system under test. In one space (space 1), an imager such as a digital camera 14 produces a series of images, mapping the rays through some defined pupil (e.g., aperture 16). In the other space (space 2), on the other side of the optical system under test 12, a pixilated screen 18 determines ray positions, using shifted sinusoidal patterns to determine phase on the screen 18. By imaging the screen 18 through the system under test 12, and observing the way the rays of light from the screen 18 are deviated, the system under test 12 can be measured.

One ray can be defined for each pixel on the imager 14, and its conjugate pixel on the screen 18 can be determined to some (generally, high) accuracy. In describing embodiments provided by the present disclosure, it is advantageous to first define a mathematical model for this conventional measurement system 10. The following notation is first defined, for a vector x, having some x,y coordinates, at some specific plane or space:

\vec{x_{z}_{ₙ}}= [symbol] x,y [symbol] , where z=zₙ

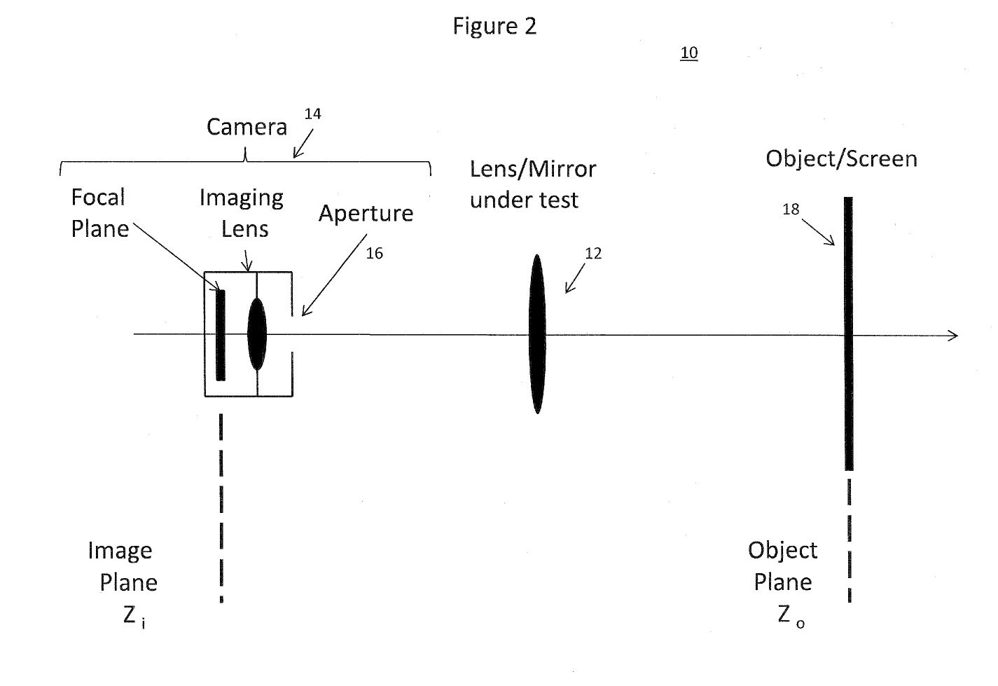

We then describe the test system 10 as mapping the first space, conventionally a plane, on one side of the optic, to the second space, or plane. As shown in FIG. 2, we label one side Zᵢ, or image, and one side Z_{O}, or object. At each plane, we have knowledge of the ray positions, at some resolution:

f(\vec{x_{z}_{ₒ}})=\vec{x_{z}_{ₗ}}

We then construct the operator G, and its inverse. G operates on the refractive index variation n(x), where the refractive index variation is a model of the optical system under test, such as a lens 12. It will be readily appreciated, however, that the present invention is suitable for measuring optical elements and systems that are defined with other models.

The result of the operator G acting on the index variation n(x) is our data, f(x), the ray mapping. If we apply G inverse to our data, we get the refractive index variation. This simply states that we can conduct our Phase Measuring Deflectometry measurement and gain information about the optic being tested. Summarized mathematically, this is:

G{n(x,y)}=f(\vec{x_{z}_{ₒ}})

G⁻¹{f(\vec{x_{z}_{ₒ}})}=n(x,y)

We note, however, that n(x) must be two-dimensional, or quasi-two-dimensional, as our mapping only has two degrees of freedom. This is a significant limitation of the conventional test, as, again, conventional Phase Measuring Deflectometry can only measure a single surface, or the overall transmitted wavefront. It cannot separate, for example, the two surfaces of a lens. This is, as the above equations show, a fundamental limitation of the data.

The present invention overcomes this fundamental limitation of conventional Phase Measuring Deflectometry by obtaining more information during measurement. The present disclosure provides several methods for accomplishing this objective. In general, a full mapping of the rays on both sides of the optic under test can be obtained, and the accuracy and completeness of that measurement can be improved.

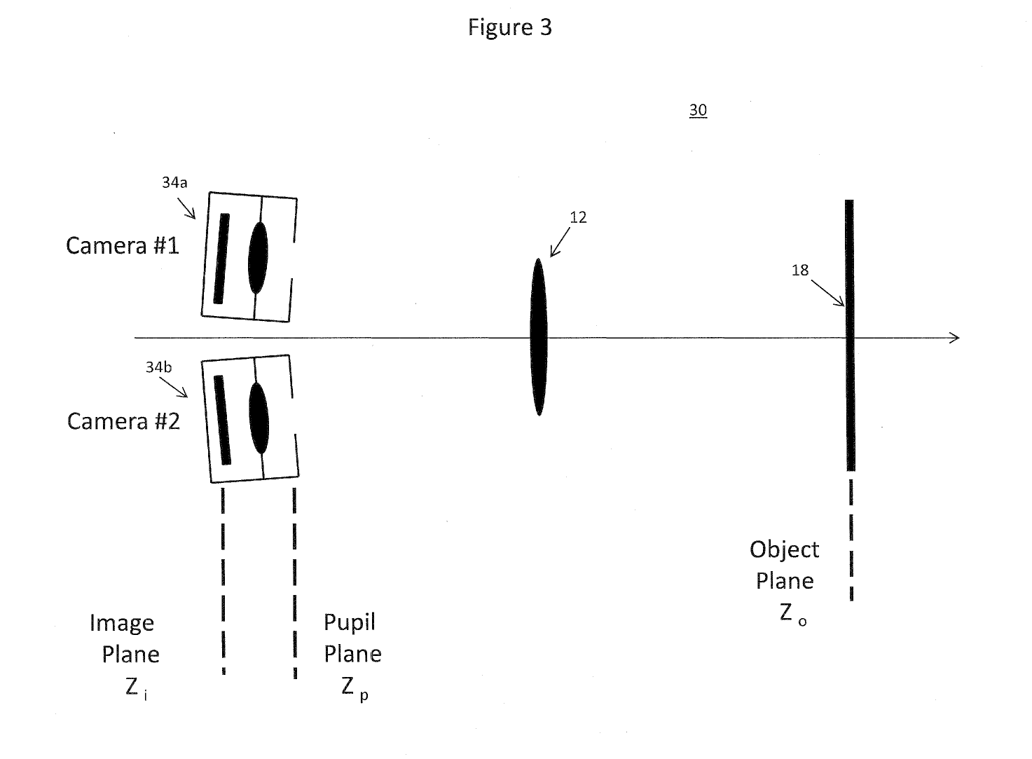

FIG. 3 is a schematic diagram illustrating a system 30 for measuring an optical system which achieves the goal of providing full ray mapping, using multiple imagers 34a, 34b in place of the single digital camera in the conventional system of FIG. 1.

As shown in FIG. 3, an additional plane of resolution is added to the system 30, a pupil plane, Zₚ. In the simplest case, with two cameras 34a, 34b, this plane offers two points of resolution, one for each camera pupil. High-resolution knowledge of the rays may thus be retained at the image and object plane.

The equation for the system's 30 ray-mapping is thus as follows:

f(\vec{x_{z}_{ₒ}},\vec{x_{z}_{ₚ}})=\vec{x_{z}_{ₗ}}

Critically, this mapping now has additional information about the ray paths, from this added plane of resolution, the pupil plane. We can now write a model of our system 30, n(x), that includes depth, z, information.

G{n(x,y,z)}=f(\vec{x_{z}_{ₒ}},\vec{x_{z}_{ₚ}})

G⁻¹{f(\vec{x_{z}_{ₒ}},\vec{x_{z}_{ₚ}})}=n(x,y,z)

The result of this is that the system 30, with three resolution planes, can, for example, separate errors in the first and second surfaces of a lens, or measure the index profile of a gradient index lens.

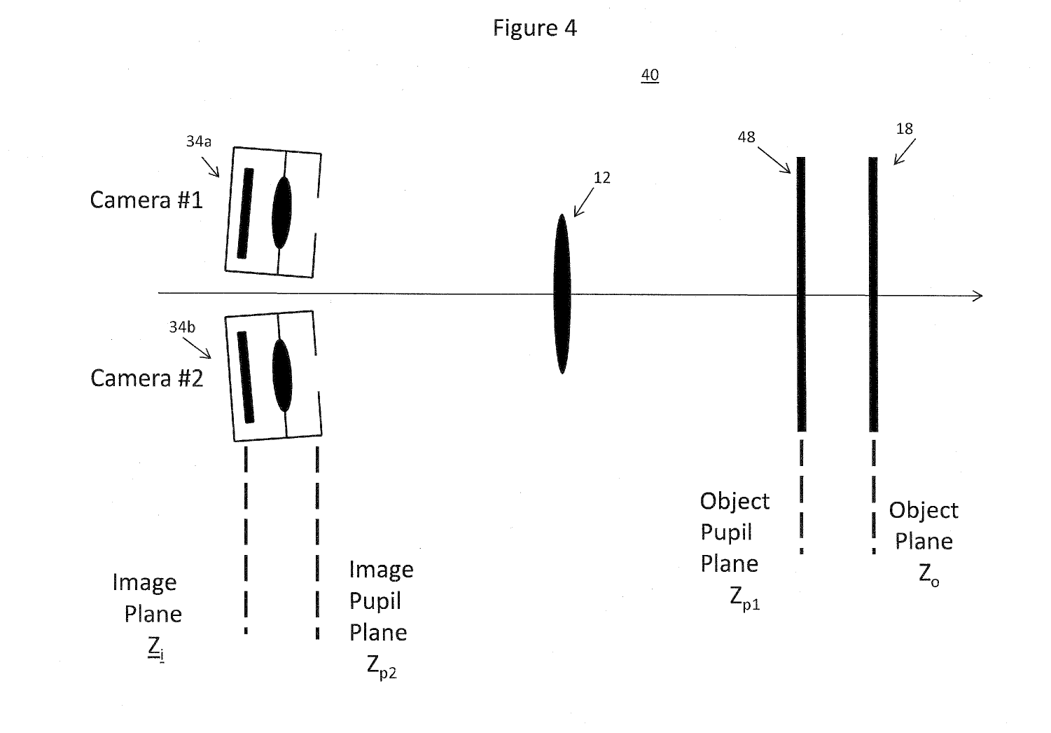

To be fully general, however, four planes of resolution may be required. FIG. 4 is a schematic diagram illustrating a system 40 for measuring an optical system, with four planes of resolution. In such a system 40, the ray angle and direction must be known both going into and leaving the optical system 12 being tested.

By making at least two measurements with the screen 18 displaced, or with two screens and a beam splitter, this can be achieved. Alternately, some object 48 may be inserted into a second pupil plane between the screen 18 and the optic under test 12. The it system 40 model, with these two pupil planes (e.g., image pupil and object pupil planes), now becomes:

f(x_{z}_{ₒ},x_{z}_{ₚ₁})=<x_{z}_{ₗ},x_{z}_{ₚ₂}>

Using a fully general operator G, we can again define:

G⁻¹{f(x_{z}_{ₒ},x_{z}_{ₚ})}=n(x,y,z)

As full resolution is obtained at all four planes, n(x) becomes fully general, and can have any sort of Z information. Because any optical system's ray-propagation can be measured, the measurement systems and methods provided herein are termed FORM (Flexible Optical Ray Metrology).

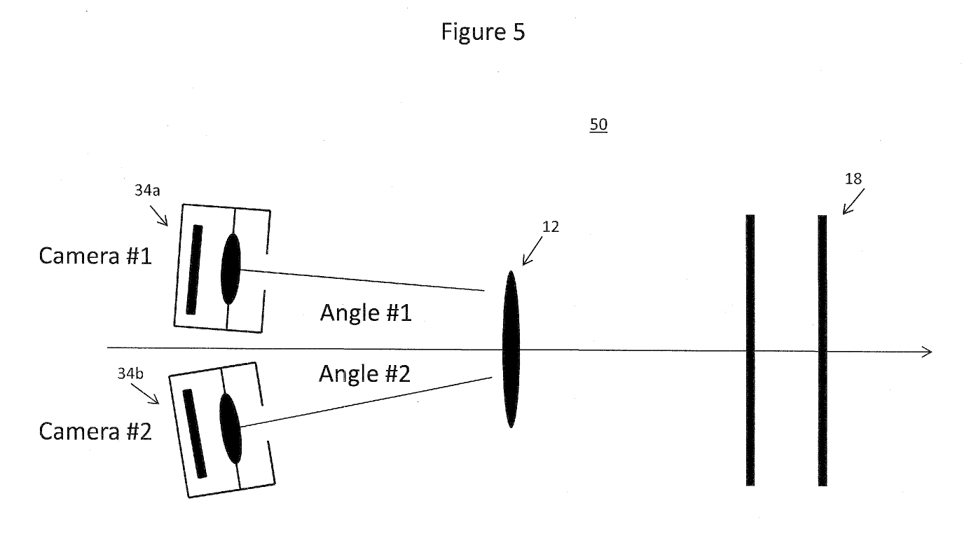

The present disclosure provides several systems and methods for creating these four planes of resolution. Resolution at the image, and on the object, can generally be created using a CMOS or CCD detector (e.g, camera 34a, 34b) and an LCD screen (e.g., screen 18), respectively. Resolution in the image pupil plane may be created utilizing several systems and methods, including the systems shown in FIGS. 5 through 9 herein.

FIG. 5 is a schematic diagram illustrating a system 50 for measuring an optical system, in accordance with an exemplary embodiment of the present disclosure. The system 50 includes multiple detectors (e.g., 34a, 34b), each having different angles of incidence (e.g., angle #1, angle #2), thus providing resolution in the image pupil plane.

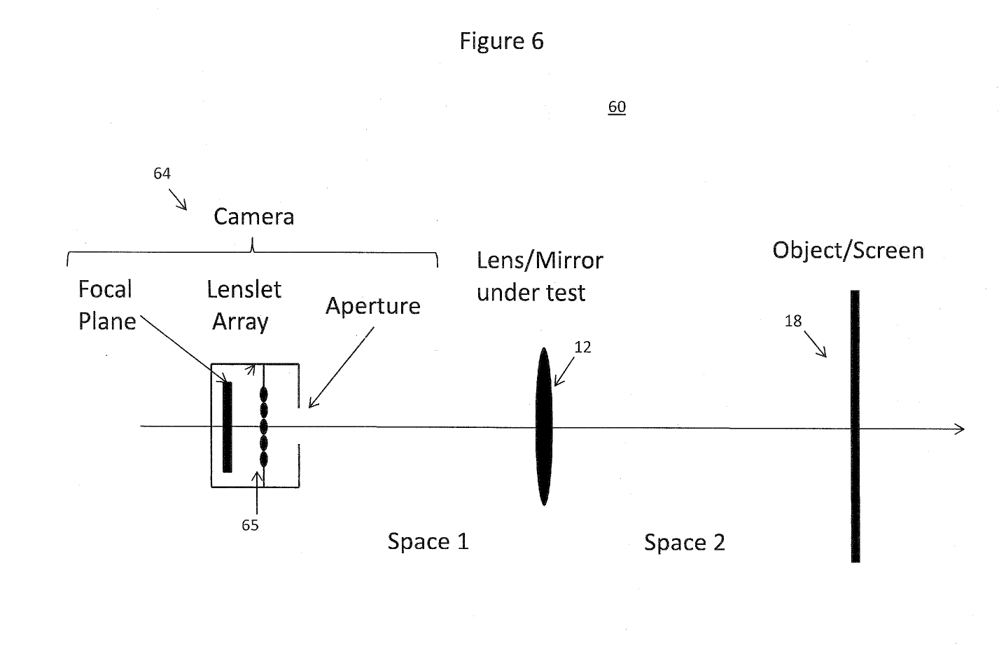

FIG. 6 is a schematic diagram illustrating a system 60 for measuring an optical system, in accordance with another embodiment of the present disclosure. The system 60 includes a detector 64 having a lenslet array 65, thus providing resolution in the image pupil plane.

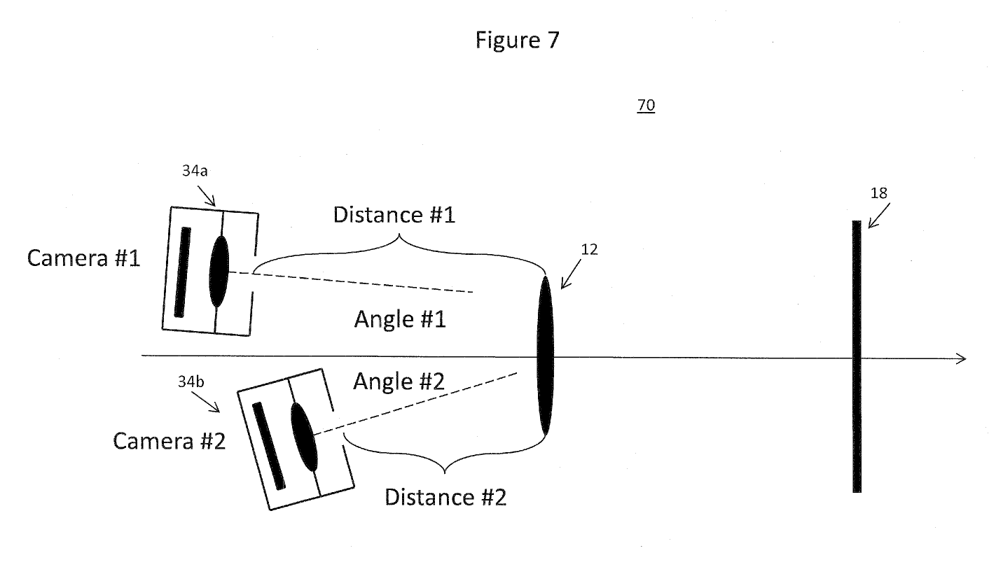

FIG. 7 is a schematic diagram illustrating a system 70 for measuring an optical system, in accordance with another embodiment of the present disclosure. The system 70 includes one or more detectors 34a, 34b, each positioned at different depths, or Z distances (distance #1, distance #2), thus providing resolution in the image pupil plane.

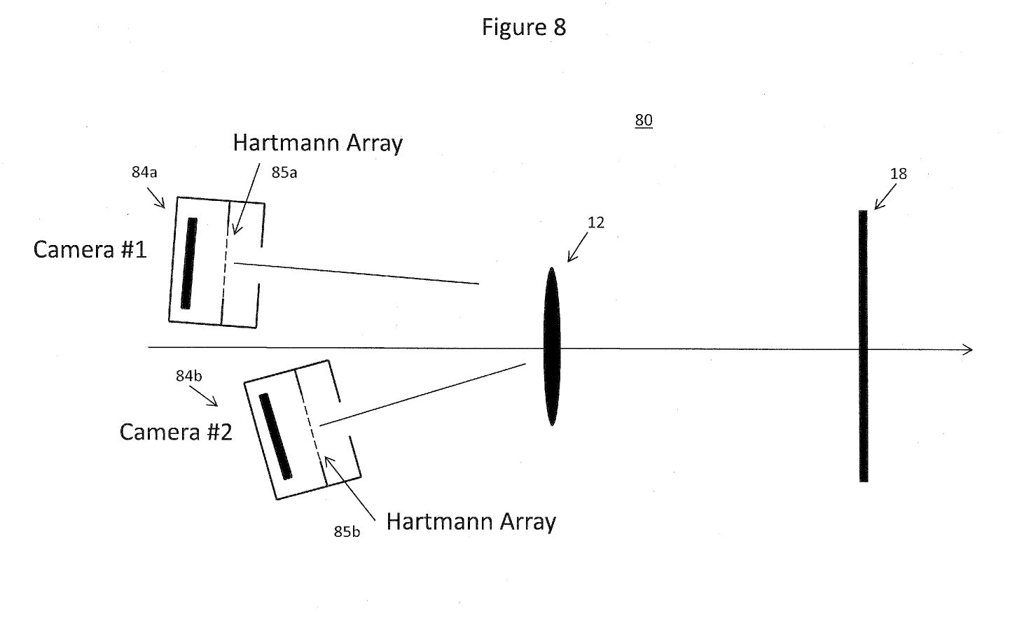

FIG. 8 is a schematic diagram illustrating a system 80 for measuring an optical system, in accordance with another embodiment of the present disclosure. The system 80 includes one or more detectors 84a, 84b with a Hartmann screen or array 85a, 85b, thus providing resolution in the image pupil plane.

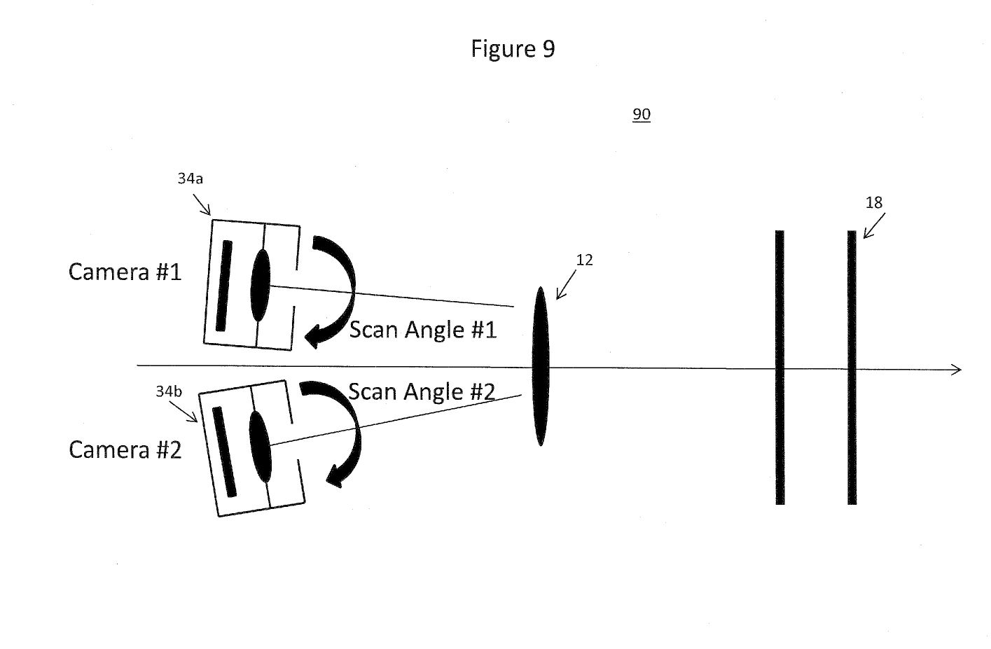

FIG. 9 is a schematic diagram illustrating a system 90 for measuring an optical system, in accordance with another embodiment of the present disclosure. The system 90 includes one or more detectors 34a, 34b which are scanned in angle scan angles #1 and #2, as shown in FIG. 9) or scanned in position, thus providing resolution in the image pupil plane.

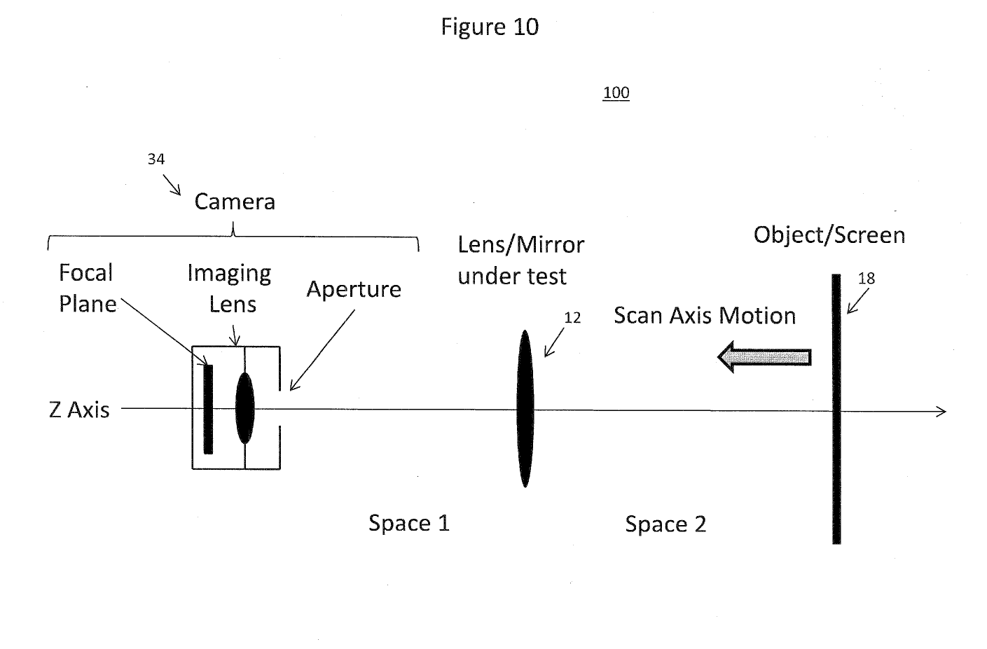

Further, resolution in the object pupil plane may be created utilizing various systems and methods, including the systems shown in FIGS. 10 through 13 herein.

FIG. 10 is a schematic diagram illustrating a system 100 for measuring an optical system, in accordance with another embodiment of the present disclosure. The system 100 includes a single screen 18, which is scanned in the Z direction, or depth, thus providing resolution in the object pupil plane.

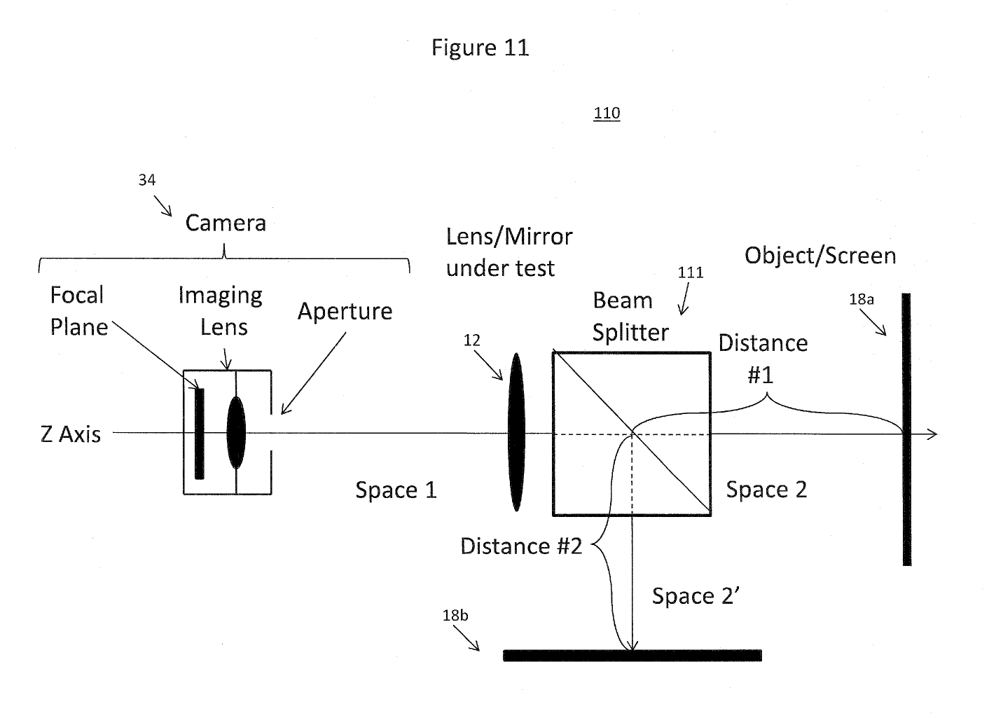

FIG. 11 is a schematic diagram illustrating a system 110 for measuring an optical system, in accordance with another embodiment of the present disclosure. The system 110 includes a plurality of screens 18a, 18b, each at different Z distances (distance #1, distance #2), optically coupled with a beamsplitter 111, thus providing resolution in the image pupil plane.

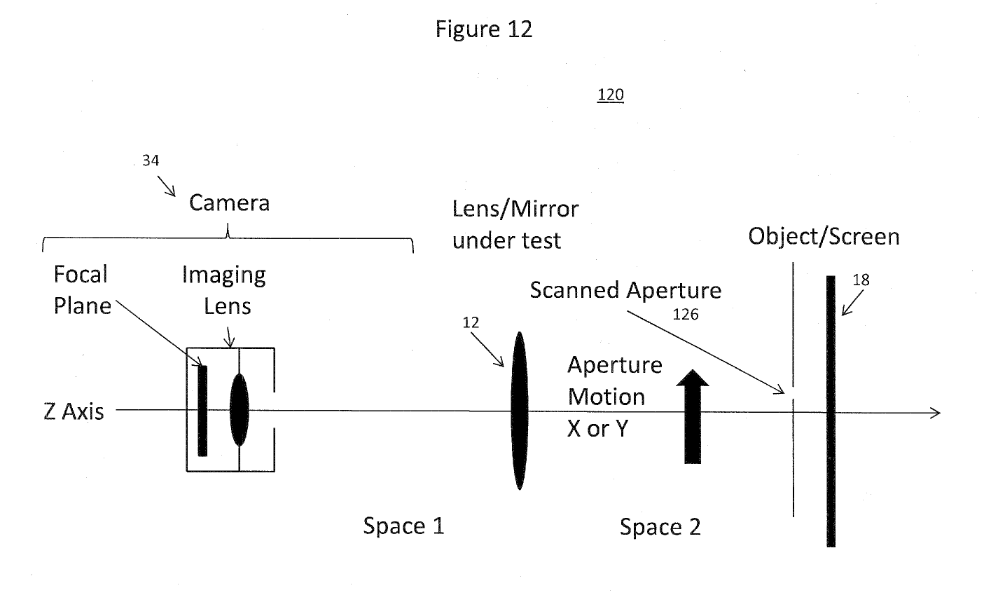

FIG. 12 is a schematic diagram illustrating a system 120 for measuring an optical system, in accordance with another embodiment of the present disclosure. The system 120 includes an aperture 126 or series of apertures in the object pupil plane, which may be scanned in the X and/or Y directions, thus providing resolution in the image pupil plane.

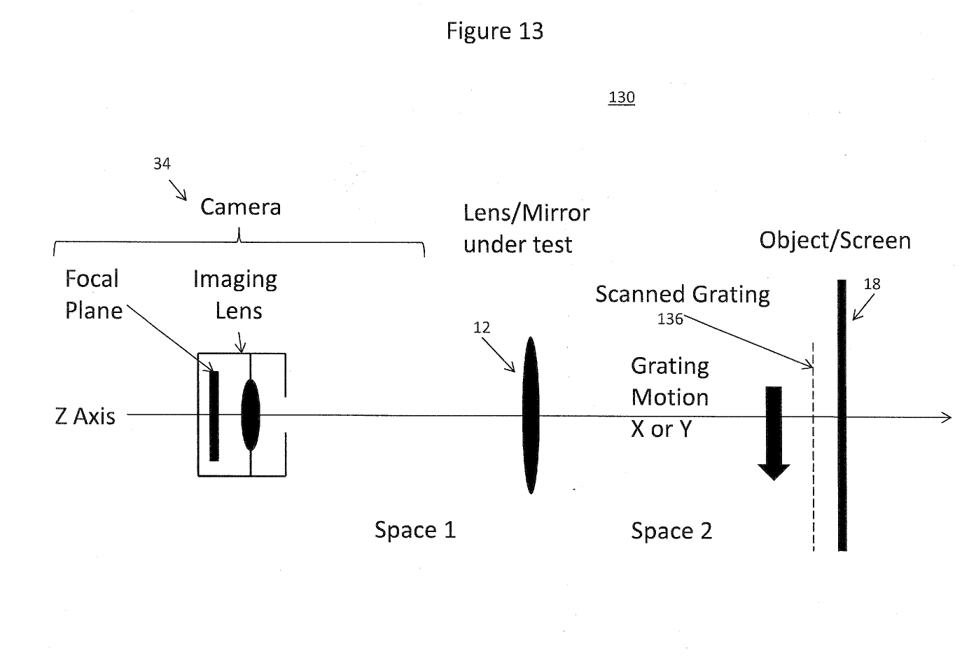

FIG. 13 is a schematic diagram illustrating a system 130 for measuring an optical system, in accordance with another embodiment of the present disclosure. The system 130 includes a grating 136 positioned in the object pupil plane, which may be moved or phase shifted in the X and/or Y directions, thus providing resolution in the image pupil plane.

As will be understood by those skilled in the relevant art, the systems and methods provided herein for providing resolution in the image pupil plane (e.g., as shown in FIGS. 5 through 9) may be combined with those for providing resolution in the object pupil plane (e.g., as shown in FIGS. 10 through 13), as desired, so that partial or full resolution may be created at one or both pupil planes (i.e., the image pupil plane and the object pupil plane). Moreover, it will be readily understood by those skilled in the relevant art that partial or full resolution may be created at additional planes utilizing various combinations of the systems and methods provided herein. All such combinations are intended to be included herein within the scope of this disclosure.

It should be noted that although the analogy of rays is used with respect to the measurement systems provided herein, rays are non-physical. Fundamentally, the wave nature of light is apparent in the data. Thus, there is no loss of generality, and wave-optics phenomena such as diffraction may be observed. In particular, a ray analysis would seem to require continuous surfaces for measurement. However, because measurements in accordance with the disclosure are wave-optics tests, discontinuities in surface sag or slope may be accurately measured.

The present disclosure thus enables measurement of both surfaces of a lens or optical system under test, a significant advantage over conventional measurement techniques. Furthermore, the present disclosure facilitates improved accuracy and resolution of the data. Noting again that wave-optics phenomena are significant, the details and characteristics of each pupil in the pupil planes (e.g., image and object pupil planes) are significant with respect to accuracy and resolution. For the camera or image pupil, there are advantages provided by comparatively large and small pupils. A large pupil allows more light to be collected, and, due to diffraction, creates a smaller image at the surface being tested, allowing for higher resolution.

A smaller pupil, by contrast, creates more diffraction, reducing resolution at the surface being tested, but creating more well-defined rays, allowing small slopes with big extents to be accurately measured, and reducing the effects of certain systematic errors. This greater diffraction also allows discontinuities to be measured more effectively.

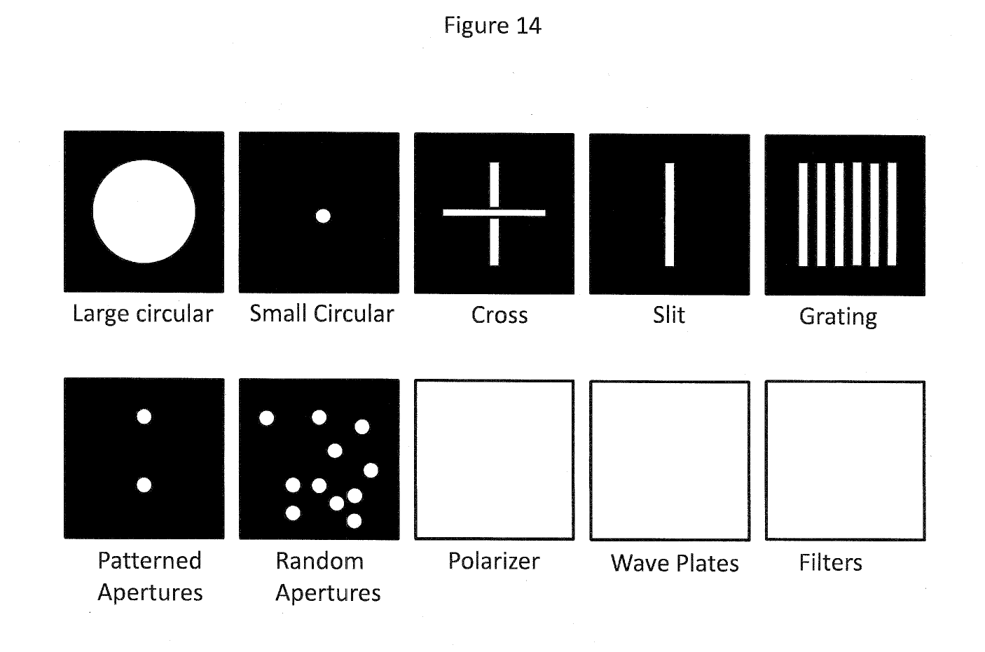

Other sorts of pupils besides simply large and small may be considered and utilized in any of the systems and methods provided herein. FIG. 14 illustrates a variety of pupil types and features which may be utilized. For example, non-circular stops may be utilized, such as slits, crossed slits, and groups or gratings of slits. Pairs or arrays of circular or non-circular holes may also be utilized. Each of these offers tradeoffs of resolution and diffraction behavior.

Similarly, various optical elements may be placed in the pupil planes and utilized in any of the systems and methods provided herein. Polarizers, waveplates, spatial light modulators and the like may be introduced in a pupil plane to allow polarization behavior to be studied. Color filters, gratings and prisms may be introduced to allow color information to be captured. With the right combination of elements, the full wave nature of light may be interrogated for the system being tested.

These various pupil features and sizes may be combined, and different pupils assigned to each camera, or the pupil may be varied at different times during the measurement. By doing so, the accuracy of the measurement may be improved, so that both very large- and small-scale features may be accurately measured, including discontinuities. Additional information may also be obtained about polarization and color effects of the optical system being tested.

The systems and methods provided herein may include an electronic computer for controlling the measurement process and/or receiving and analyzing the results of such measurements, including any such computer systems for controlling measurements of optical systems as may be known within the relevant field. The computer may be utilized in the present invention, for example, to coordinate the modulation of the optical source and/or masks and the image acquisition by the sensors. The computer may further determine the mapping relations (e.g., between points on the optical system and corresponding geometric locations of points in the diffuse optical source), and determine properties of the optical system.

Moreover, it will be appreciated that the present invention enables a calibration of errors in one or more of the sensors to be determined based on the mapping relations for each of the sensors, as well as in the optical source.

The systems and methods provided herein may be utilized to determine various properties of the optical systems or surfaces under test, including a measurement of both surface shapes for a refractive optic or for measuring a specular surface.

In some embodiments, systems and methods provided herein may perform a measurement of an optical system by measuring a first portion of the optical system while the optical system is in a first position and then measuring a second portion of the optical system while the optical system is in a second position. A measurement of the full optical system is then generated by combining the measurements of the first and second portions.

Similarly, the position of the optical system may be rotated, thereby enabling measurement of optical systems having an angular acceptance too large for measuring in a single measurement.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of measuring an optical system, comprising:
illuminating the optical system using a modulated diffuse optical source;
simultaneously imaging light that has been altered by the optical system using a plurality of sensors positioned at different vantage points;
determining, based on images from each of the sensors, the mapping relations between points on the optical system and corresponding geometric locations of points in the diffuse optical source; and
determining, based on the mapping relations for each of the sensors, properties of the optical system.

2. The method according to claim 1, characterized by one or more of the following features:
(a) wherein the optical source comprises patterns displayed on a digital display, and optionally varying the position of the digital display;
(b) wherein the optical source comprises patterns displayed on two digital displays, said displays having different positions and being coupled through a beamsplitter;
(c) wherein the optical source comprises an array of small sources that are modulated in position within a plane;
(d) wherein the optical source comprises an array of small sources that are modulated in position in three dimensions;
(e) wherein the optical source comprises a linear source that is modulated in position within a plane;
(f) wherein the optical source comprises a linear source that is modulated in position in three dimensions;
(g) wherein the optical source comprises an array of point sources that remain fixed, but have their image modulated with a moving mirror; and
(h) wherein the optical source comprises an array of point sources that remain fixed, but have their image modulated with a moving lens or optical element.

3. The method according to claim 1, further comprising:
positioning an occluding mask between the optical source and the optical system, and optionally, further comprising:
modulating the position of the occluding mask.

4. The method according to claim 3, wherein the occluding mask is a grating, and optionally, wherein the grating is phase shifted.

5. The method according to claim 1, characterized by one or more of the following features:
(a) wherein the determined properties comprise prescription parameters for the optical system;
(b) wherein the determined properties comprise coefficients that describe modes for shape irregularity for one of more surfaces in the optical system;
(c) wherein the determined properties comprise the shape of a reflective surface of the optical system;
(d) wherein the determined properties comprise the phase of the transmitted wavefront of the optical system;
(e) further comprising:
determining, based on the mapping relations for each of the sensors, a calibration of errors in one or more of the sensors;
(f) further comprising:
determining, based on the mapping relations for each of the sensors, a calibration of errors in the optical source;
(g) wherein the determined properties comprise both surface shapes for a refractive optic, and wherein the optical system comprises a specular surface, and/or the position of the optical system is rotated, thereby enabling measurement of optical systems having an angular acceptance too large for measuring in a single measurement
(h) wherein the determined properties comprise the shape of a plurality of reflective and/or refractive surfaces of an optical system;
(i) wherein the determined properties comprise the diffractive behavior of the optical system;
(j) further comprising:
varying the position of the optical system, and optionally further comprising:
measuring a first portion of the optical system while the optical system is in a first position;
measuring a second portion of the optical system while the optical system is in a second position; and
generating a measurement of the full optical system by combining the measurements of the first and second portions.

6. A method of measuring a specular optical surface, comprising:
illuminating the surface using a modulated diffuse optical source;
simultaneously imaging light that has been reflected by the surface using a plurality of sensors, each of said sensors having a pupil with a different size or shape; and
determining, based on images from each of the sensors, discontinuities of slope and height and variations in reflectivity or transmission of the optical surface.

7. The method according to claim 6, characterized by one or more of the following features:
(a) wherein the plurality of sensors provide different measurements of the properties of the optical surface on the basis of their respective pupils, wherein the different properties preferably include the shape of one or more reflective or refractive surfaces at different length- or spatial-scales;
(b) wherein one or more different optical element(s) are positioned in the pupil of each of the plurality of sensors, wherein the one or more optical element(s) preferably comprise at least one of: a waveplate, a polarizer, a depolarizer, a filter, an attenuator, a lens, a diffractive element, a hologram and any other element which changes the properties of the light incident on the detector;
(c) further comprising:
varying the position of the optical surface, and optionally further comprising:
measuring a first portion of the optical surface while the optical surface is in a first position;
measuring a second portion of the optical surface while the optical surface is in a second position; and
generating a measurement of the full optical surface by combining the measurements of the first and second portions; and
(d) further comprising:
determining, based on the mapping relations for each of the sensors, a calibration of errors in at least one of: the sensors and the optical source.

8. An apparatus for measuring an optical system, comprising:
a modulated diffuse optical source for illuminating the optical system during measurement;
a plurality of imagers, each having a pupil, said plurality of imagers positioned to image light that has been altered by the optical system during measurement; and
an electronic computer configured to:
coordinate the modulation of the optical source and the image acquisition by the plurality of imagers, and
determine the ray mapping between first and second optical spaces of the optical system, wherein the first optical space comprises an optical space between the optical source and the optical system, and the second optical space comprises an optical space between the plurality of imagers and the optical system.

9. The apparatus according to claim 8, characterized by one or more of the following features:
(a) wherein the electronic computer is further configured to determine properties of the optical system;
(b) wherein the optical source comprises a digital display;
(c) further comprising a mechanism for varying the position of the digital display;
(d) wherein the optical source comprises two digital displays, said displays having different positions and being coupled through a beamsplitter;
(e) wherein the optical source comprises an array of small sources that are modulated in position within a plane;
(f) wherein the optical source comprises an array of small sources that are modulated in position in three dimensions;
(g) wherein the optical source comprises a linear source that is modulated in position within a plane;
(h) wherein the optical source comprises a linear source that is modulated in position in three dimensions;
(i) wherein the optical source comprises an array of point sources that remain fixed, and the apparatus further includes a movable mirror for modulating the image of the array of point sources; and
(j) wherein the optical source comprises an array of point sources that remain fixed, and the apparatus further includes a movable lens or optical element to modulate the image of the array of point sources.

10. An apparatus for measuring an optical surface, comprising:
a modulated diffuse optical source for illuminating the optical surface during measurement;
a plurality of imagers, each having a pupil, said plurality of imagers positioned to image light that has been reflected by the optical surface during measurement; and
an electronic computer configured to:
coordinate the modulation of the optical source and the image acquisition by the plurality of imagers, and
determine, based on images acquired by the imagers, the optical surface shape, discontinuities of slope and height and variations in reflectivity or transmission of the optical surface.

11. The apparatus according to claim 10, characterized by one or more of the following features:
(a) wherein the optical source comprises a digital display, and optionally further comprising a mechanism for varying the position of the digital display.
(b) wherein the optical source comprises two digital displays, said displays having different positions and being coupled through a beamsplitter;
(c) further comprising a mechanism for varying the position of the optical surface; and
(d) wherein the electronic computer is further configured to:
determine the complete optical surface shape, including discontinuities.

12. An apparatus for measuring an optical surface, comprising:
a modulated diffuse optical source for illuminating the optical surface during measurement;
a modulated mask positioned between the optical source and the optical surface during measurement;
an imager having a pupil, said imager positioned to image light that has been reflected by the optical surface during measurement; and
an electronic computer configured to:
coordinate the modulation of the optical source and the mask, and the image acquisition by the imager, and
determine, based on images acquired by the imagers, the optical surface shape including discontinuities of slope and height and variations in reflectivity or transmission of the optical surface.

13. The apparatus according to claim 12, characterized by one or more of the following features:
(a) wherein the optical source comprises a digital display, and optionally further comprising a mechanism for varying the position of the digital display;
(b) further comprising a mechanism for varying the position of the mask;
(c) wherein the optical source comprises two digital displays, said displays having different positions and being coupled through a beamsplitter;
(d) wherein the mask includes one or more gratings;
(e) wherein the modulation of the mask comprises phase-shifting;
(f) wherein the optical source and mask form a moiré pattern, and optionally wherein the electronic computer is further configured to analyze the moiré pattern;
(g) further comprising a mechanism for varying the position of the optical surface;
(h) wherein the electronic computer is configured to determine the complete surface shape, including discontinuities; and
(i) comprising a plurality of imagers, and wherein at least one of the plurality of imagers preferably has a pupil of a different size or shape from at least another one of the plurality of imagers.

14. An apparatus for measuring an optical system, comprising:
a modulated diffuse optical source for illuminating the optical surface during measurement;
a plurality of imagers, each having a pupil, said imagers positioned to image light that has been altered by the optical system during measurement, and the pupils being arrayed to increase capture range or measurement area; and
an electronic computer configured to:
coordinate the modulation of the optical source and the image acquisition by the plurality of imagers, and
determine the ray mapping between first and second optical spaces of the optical system, wherein the first optical space comprises an optical space between the optical source and the optical system, and the second optical space comprises an optical space between the plurality of imagers and the optical system.

15. The apparatus according to claim 14, characterized by one or more of the following:
(a) wherein the optical source comprises multiple sources arrayed to increase capture range or measurement area; and
(b) wherein the pupils are arrayed to further increase dynamic range, and wherein the multiple sources preferably are further arrayed to increase dynamic range.
